(19) United States
(12) Patent Application Publication
(10) Pub. No.: US 2023/0325490 A1
(43) Pub. Date: Oct. 12, 2023

(54) AGENT-BASED EXTRACTION OF CLOUD CREDENTIALS

(71) Applicant: Microsoft Technology Licensing, LLC, Redmond, WA (US)

(72) Inventors: Josef WEIZMAN, Haifa (IL); Ram Haim PLISKIN, Rishon Lezion (IL); Lior SONNTAG, Givatayim (IL)

(21) Appl. No.: 17/715,755

(22) Filed: Apr. 7, 2022

(51) Int. Cl. G06F 21/45

(52) U.S. Cl. CPC G06F 21/45

(57) ABSTRACT

A computing system is configured to cause an agent to be installed at a cloud consumer computing system. The cloud consumer computing system is configured to access a cloud service. The agent is configured to scan at least a portion of storage of the cloud consumer computing system for a data pattern associated with a credential. In response to finding the data pattern associated with the credential, the agent sends the data pattern to the computing system. In response to receiving the data pattern, the computing system is configured to extract an identifier associated with the credential based on the data pattern, identify a scope of permission to which the identifier is granted, and mitigate a risk of potential exposure of the credential.

### BACKGROUND

A cloud generally refers to an information technology (IT) environment that is designed for the purpose of remotely provisioning scalable and measured IT resources (hereinafter also referred to as resources). A resource may be a physical or virtual artifact that can be either software-based or hardware-based. Software-based resources include (but are not limited to) a virtual server or a custom software program. Hardware-based resources include (but are not limited to) a physical server or a network device.

A cloud service is a resource that is made remotely accessible via a cloud. As a remotely accessible environment, a cloud service represents an option for the deployment of resources. A cloud service provider is a party that provides cloud services. A cloud service consumer is a runtime role assumed by a software program, a hardware device, or a combination thereof when it accesses a cloud service. Common types of cloud service consumers include (but are not limited to) software programs and services capable of remotely accessing cloud services, and/or workstations, laptops, and/or mobile devices running software capable of remotely accessing resources positioned as cloud services.

Recently, more and more organizations have moved their IT resources to clouds. It is crucial to secure access to those resources. There are multiple methods to authenticate users for accessing cloud resources. Many of these methods involve storing credentials on a resource, risking exposure of the credentials to malicious actors. For example, a cloud provider may allow users to manage their resources using a command-line interface (CLI) from a cloud consumer computing system. After the user enters their credentials over the CLI, the credentials may be stored on a local storage of the cloud consumer computing system, potentially allowing anyone with access to the local storage to read the credentials.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to a computing system configured to cause an agent to be installed at a cloud consumer computing system. The cloud consumer computing system is configured to access a cloud service. The agent is configured to scan at least a portion of storage of the cloud consumer computing system for a data pattern associated with a credential. In response to finding the data pattern associated with the credential, the agent is configured to send the data pattern to the computing system.

In response to receiving the data pattern associated with the credential from the agent, the computing system is configured to extract an identifier associated with the credential and identifies a scope of permission, to which the identifier is granted. The scope of permission is associated with a permission to access a cloud resource. In some embodiments, the computing system is also configured to identify an owner of the cloud resource.

Finally, the computing system is configured to mitigate a risk of potential exposure of the credential, which includes (but is not limited to) at least one of (1) generating a security alert, notifying an owner of the cloud resource, (2) causing the agent to delete the credential from the cloud consumer computing system, (3) modifying or revoking the scope of permission associated with the credential, and/or (4) resetting a password associated with the credential.

In some embodiments, identifying the scope of permission includes obtaining a permission to access a user database that stores identifiers and scopes of permission relationally, querying the user database to obtain the scope of permission and the cloud resource associated therewith based on the identifier, and/or querying the user database to obtain an owner of the cloud resource.

In some embodiments, the data pattern is one of a plurality of predetermined data patterns. In some embodiments, the plurality of predetermined data patterns include (but are not limited to) at least one of (1) a cloud service password of a principal, (2) a cloud service certificate of a principal, (3) a cloud service command line (CLI) token, (4) a cloud service CLI credential, (5) a cloud application service publish setting file, (6) a Kubernetes kubeconfig file, (7) a cloud storage connection string, (8) a container registry credential, (9) a relational database service (RDS) secret, and/or (10) an OpenShift configuration file.

In some embodiments, in response to finding a cloud service password of a principal, the computing system is configured to identify a resource that the principal has access to or a project that the principal has access to. In some embodiments, in response to finding a Kubernetes kubeconfig file, the computing system is configured to identify a workload or a secret in a Kubernetes cluster. In some embodiments, in response to finding a cloud storage connection string, the computing system is configured to identify a container, a blob, or a bucket that a credential associated with the cloud storage connection string has access to. In some embodiments, in response to finding a container registry, the computing system is configured to identify a repository in the container registry and a scope of permission that a credential associated with the container registry has.

The embodiments described herein are also related to a method for finding credentials from a cloud consumer computing system. The method can be performed by a credential analysis service. The method includes installing an agent at a cloud consumer computing system. The cloud consumer computing system is configured to access a cloud service. The agent is configured to scan at least a portion of cloud storage to search for a data pattern associated with a credential. In response to finding a data pattern associated with the credential, the agent is configured to send the data pattern to a credential analysis service. In response to receiving the data pattern, the credential analysis service is configured to extract an identifier associated with the credential. Based on the identifier, a scope of permission, to which the identifier is granted, is then identified. The scope of permission is associated with a permission to access a cloud resource. In some embodiments, the method also includes identifying an owner of the cloud resource.

The method also includes mitigating a risk of potential exposure of the credential. Mitigating the risk of potential exposure of the credential includes (but is not limited to) at least one of (1) generating a security alert, notifying an owner of the cloud resource, (2) causing the agent to delete the credential from the cloud consumer computing system, (3) modifying or revoking the scope of permission associated with the credential, and/or (4) resetting a password associated with the credential.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1A illustrates an example system in which an agent installed at a cloud consumer computing system and a credential analysis service implemented at a cloud service provider are configured to identify and analyze credentials stored in a local storage of the cloud consumer computing system;

FIG. 1B illustrates another example system in which an agent installed at a cloud consumer computing system and a credential analysis service separate from a cloud service provider are configured to identify and analyze credentials stored in a local storage of the cloud consumer computing system;

FIG. 1C illustrates another example system in which an agent installed at each cloud consumer computing system and a credential analysis service implemented at a first cloud service provider configured to identify and analyze credential stored in each cloud consumer computing system;

FIG. 2A illustrates an example process of finding credentials from a local storage of a cloud consumer computing system;

FIG. 2B illustrates another example process of finding credentials from a local storage of a cloud consumer computing system;

FIG. 3 illustrates a flowchart of an example method for finding a credential from a local storage of a cloud consumer computing system;

FIG. 4 illustrates a flowchart of an example method for identifying a scope of permission to which an identifier is granted; and

FIG. 5 illustrates an example computing system in which the principles described herein may be employed.

### DETAILED DESCRIPTION

As more and more organizations move their IT assets to the cloud, it is crucial to secure access to those resources. There are multiple ways to authenticate with cloud resources. Many of them involve credentials that are stored on computing resources that are local to cloud consumer computing systems, such as (but not limited to) plaintext credentials or client certification. For example, some cloud providers allow users to manage their resources using a CLI (Command Line Interface). Often, the credentials for the CLI are stored locally at the cloud consumer computing resource, allowing anyone with local access to the cloud resource to read the credentials and laterally move the cloud resources and possibly achieve privilege escalation.

The principles described herein provide a novel method to discover credentials stored on cloud consumer computing resources. The method offers software that might run on cloud service computing resources, as well as cloud consumer computing resources. The method includes installing an agent on a cloud consumer computing resource. The agent is configured to run one or more scans on the filesystem of the cloud consumer computing resource to find cloud-related credentials. Alternatively, the agent is configured to transmit at least a portion of data stored on the filesystem to a credential analysis service.

The cloud-related credentials can generally be categorized into two categories: (1) credentials for cloud environments, and (2) credentials that are used by applications that are likely to run in cloud environments. The first group can include (but is not limited to) cloud service principal passwords, cloud service principal certificates, CLI tokens, and application service publish settings files. The second group can include (but is not limited to) Kubernetes Kubeconfig files, cloud storage connection strings, container registry credentials, RDS database secrets, and OpenShift configuration file. Each credential type has its own format and/or pattern, and is usually stored in a specific location on a disk. For example, some credentials are in JSON (JavaScript Object Notation) format, some credentials are in YAML (Yet Another Markup Language) file format, some credentials are in XML (extensible markup language) file format, some credentials are text strings, etc.

In some embodiments, the different patterns and/or formats of the different types of credentials are collected and stored in a credential database to which the agent and/or the credential analysis service has access, and the file system is scanned to find those specific patterns and/or formats and extract the relevant credentials accordingly.

In some embodiments, in response to finding a credential, the agent is configured to send the credential to a credential analysis service. Alternatively, the credential analysis service is configured to find credentials based on the portion of data received from the agent. The credential analysis service is configured to extract an identifier based on the credential, and identify a scope of permission to which the identifier is granted. In some embodiments, the credential analysis service is configured to access a user database that stores identifiers and scopes of permission relationally. The credential analysis service is configured to query the user database to obtain the scope of permission and the cloud resource associated therewith based on the identifier, and query the user database to obtain an owner of the cloud resource.

In some embodiments, the credential analysis service has first-party access to the cloud resources. For example, when a credential analysis service is implemented at a cloud service provider that hosts the cloud resources, the credential analysis service has first-party access to the cloud resources that are hosted by itself. Alternatively, or in addition, permissions to access the user database are given to the credential analysis service.

In response to finding a scope of permission associated with the credential, a mitigating action can then be performed. Depending on the found credential, a different mitigation action may be performed, and/or a different report or security alert may be generated. For example, in some embodiments, when a cloud service password of a principal is found, the cloud resources that the principal has permission to are reported; when a Kubernetes kubeconfig file is found, workloads and secrets in a Kubernetes cluster are reported; when a cloud storage connection string is found, the containers, blobs, and/or buckets that the credential has access to is reported; and when a container registry credential is found, repositories in the registry and permissions that the credential has is reported.

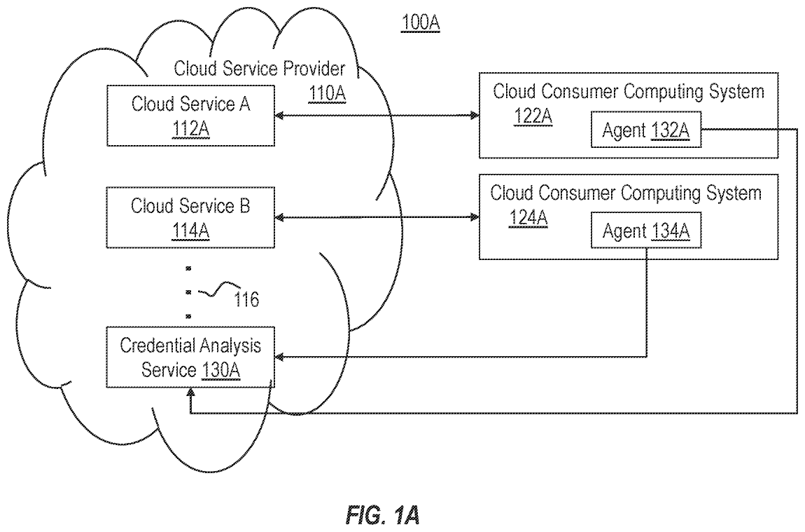

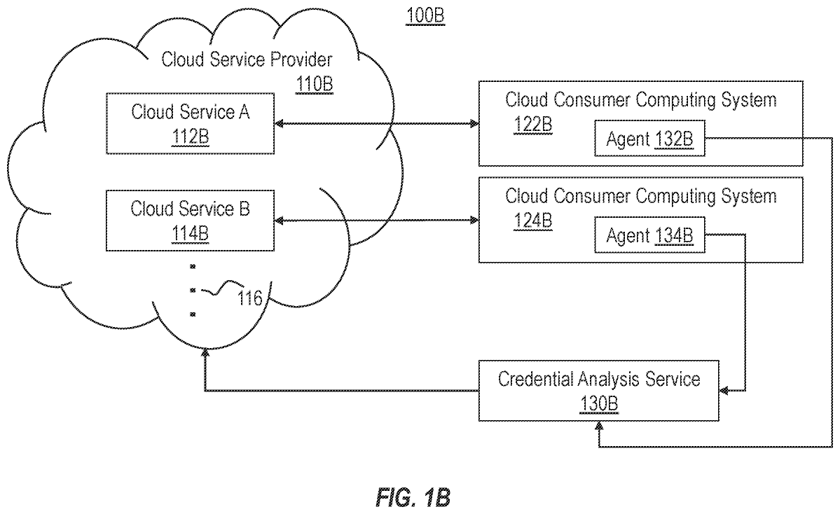

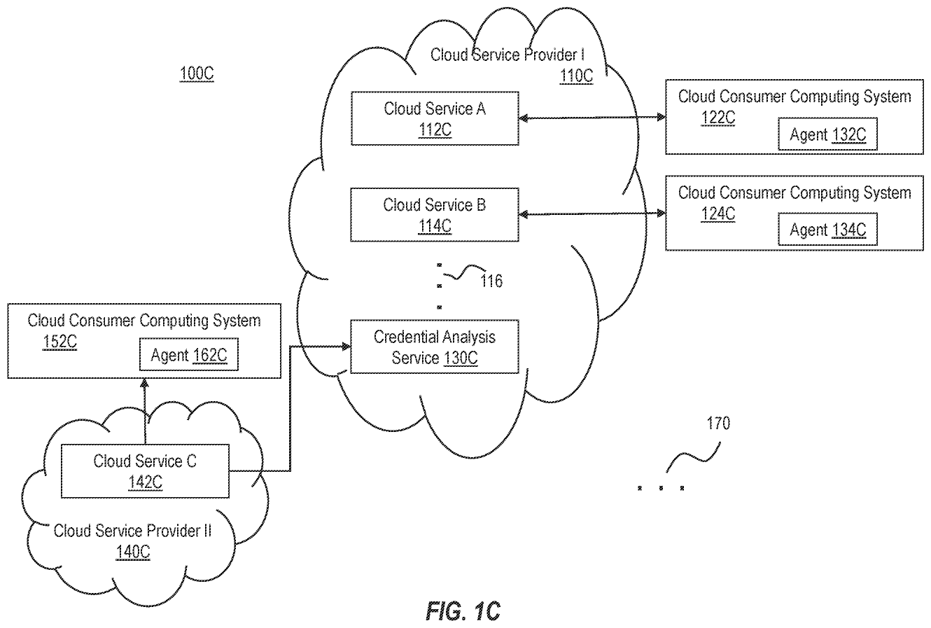

FIG. 1A illustrates an example system 100A in which the principles described herein may be implemented. The system 100A includes a cloud service provider 110A configured to host a plurality of cloud services, including cloud service A 112A and cloud service B 114A. Cloud service A 112A is accessible by a cloud consumer computing system 122A, and cloud service B 114A is accessible by a cloud consumer computing system 124A. Each cloud consumer computing system 122A, 124A has an agent 132A or 134A installed thereon. Ellipsis 116 represents that there may be any number of cloud services hosted by the cloud service provider 110A.

A cloud service (e.g., cloud service A 112A or cloud service B 114A) is a resource that is made remotely accessible via a cloud. As a remotely accessible environment, a cloud service represents an option for the deployment of resources. The cloud resources described herein may be physical resources or virtual resources. Virtualization is a process of converting a physical resource into a virtual resource. For example, a physical storage device can be abstracted into a virtual storage device or a virtual disk. The cloud resource can also include various cloud applications.

A cloud service provider (e.g., cloud service provider 110A) is a party that provides cloud services. A cloud service consumer computing system (e.g., cloud consumer computing system 122A or 124A) is a computing system on which a software program (e.g., a browser, or an agent application) is installed, and the software program allows the computing system to access a cloud service. Common types of cloud service consumer computing systems include (but are not limited to) workstations, laptops, and mobile devices running software capable of remotely accessing resources positioned as cloud services.

As illustrated in FIG. 1A, in some embodiments, a credential analysis service 130A is provided by the cloud service provider. The credential analysis service 130A is a service configured to communicate with agents 132A, 134A installed on the cloud consumer computing systems 122A, 124B to identify credentials stored locally at the cloud consumer computing systems 122A, 124B. Since the credential analysis service 130A is provided by the cloud service provider, it has first-party access to the cloud resources associated with the cloud service A 112A and the cloud service B 114A.

In some embodiments, once a credential is found, the credential analysis service 130A is configured to access a user database (e.g., based on first-party access). The user database stores identifiers and their corresponding scopes of permissions relationally. The credential analysis service 130A can query the user database to obtain the scope of permission associated with the user. The scope of permission includes a permission to access a particular cloud resource. In some embodiments, the credential analysis service 130A is also configured to identify an owner of the particular cloud resource.

In response to finding the scope of permission associated with the credential, the credential analysis service 130A then mitigates a risk of potential exposure of the credential, which includes (but is not limited to) at least one of (1) generating a security alert, notifying an owner of the cloud resource, (2) deleting the credential from the cloud storage, (3) modifying or revoking the scope of permission associated with the credential, and/or (4) changing a password associated with the credential. For example, in some embodiments, when the credential is associated with a permission to access a cloud storage associated with cloud service B 114A, the credential analysis service 130A is configured to generate a security alert to notify a security administrator of the cloud service B 114A.

FIG. 1B illustrates another example system 100B, in which the principles described herein may be implemented. Similar to the system 100A, the system 100B also includes a cloud service provider configured to provide a cloud service A 112B and a cloud service B 114B. The cloud service A 112B is accessible by cloud consumer computing system 122B, and the cloud service B 114B is accessible by cloud consumer computing system 124B. each of the cloud consumer computing systems 122B, 124B has an agent 132B, 134B installed thereon. Agent 132B or 134B is also configured to work with the credential analysis service 130B to identify credentials stored in local storage of the cloud consumer computing system 122B or 124B.

However, unlike the system 100A, the system 100B includes a credential analysis service 130B that is not associated with the cloud service provider 110B. In such a case, the credential analysis service 130B does not have first-party access to the cloud resources associated with the cloud service A 112B and the cloud service B 114B, although the cloud service A 112B or cloud service B 114B (and/or the cloud service provider 110B) can grant a scope of permission to the credential analysis service 130B to access their user database. After the credential analysis service 130B obtains the user database of the cloud service A 112B and the cloud service B 114B, the credential analysis service 130B can then identifies a scope of permission associated with a credential, and identifies an owner of a cloud resource associated with the scope of permission.

FIG. 1C illustrates another example system 100C, in which the principles described herein may be implemented. As illustrated in FIG. 1C, the system 100C includes a plurality of cloud service providers, including cloud service provider 1110C and cloud service provider II 140C. The ellipsis 170 represents that there may be any number of cloud service providers in the system 100C. Cloud service provider 1110C hosts cloud service A 112C and cloud service B 114C, which are accessible by respective cloud consumer computing systems 122C and 124C. Cloud service provider II 140C hosts cloud service C 142C, which is accessible by cloud consumer computing system 152C. An agent 132C, 134C, or 162C is installed at each of the cloud consumer computing systems 122C, 124C, and/or 152C.

Further, a credential analysis service 130C is provided by the cloud service provider 1110C, as such, the credential analysis service 130C has first-party access to the user database of cloud service A 112C and cloud service B 114C. However, the credential analysis service 130C does not have first-party access to the user database of cloud service C 142C. As such, for the credential analysis service 130C to identify scopes of permission of credentials associated with cloud service C 142C, the cloud service C 142C or the cloud service provider II 140C generally need to grant the credential analysis service 130C access to their user database.

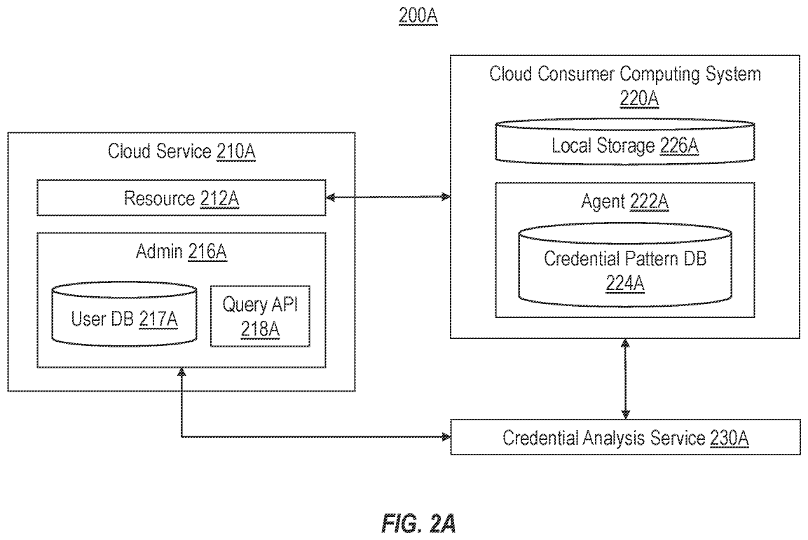

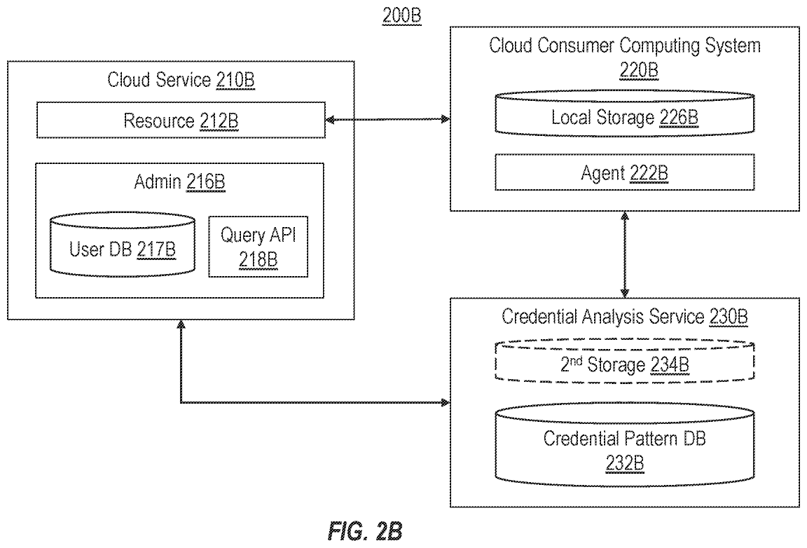

FIG. 2A illustrates an example process 200A of finding credentials from a cloud storage. As illustrated in FIG. 2A, a cloud service 210A (which corresponds to the cloud service A 112A, cloud service B 114A in FIG. 1A, or the cloud service A 112B, cloud service B 114B in FIG. 1B) has a variety of resources, including a resource 212A. Cloud consumer computing system 220A is configured to access the cloud resource 212A. At the same time, the cloud consumer computing system 220A also has some local storage, e.g., local storage 226A. In some cases, after a user of the cloud consumer computing system 220A accesses the cloud resource 212A, certain credentials may be stored locally in the local storage 226A.

To mitigate the risk of exposure of such credentials stored in the local storage 226A, an agent 222A is installed at the cloud consumer computing system 220A configured to scan at least a portion of the local storage 226A to identify a data pattern associated with a credential. In some embodiments, the data pattern is one of a plurality of predetermined data patterns corresponding to a plurality of types of credentials. In some embodiments, the plurality of predetermined data patterns include (but are not limited to) at least one of (1) a cloud service password of a principal, (2) a cloud service certificate of a principal, (3) a cloud service command line (CLI) token, (4) a cloud service CLI credential, (5) a cloud application service publish setting file, (6) a Kubernetes kubeconfig file, (7) a cloud storage connection string, (8) a container registry credential, (9) a relational database service (RDS) secret, and/or (10) an OpenShift configuration file.

Generally, each credential type has its own format and/or pattern, and is usually stored in a specific location on a disk. For example, some credentials are in JSON (JavaScript Object Notation) format, some credentials are in YAML (Yet Another Markup Language) file format, some credentials are in XML (extensible markup language) file format, some credentials are text strings, etc.

In some embodiments, the agent 222A has access to a credential pattern database 224A that stores the plurality of data patterns and/or formats associated with the plurality of types of credentials. The agent 222A is configured to scan at least a portion of the local storage 226A based on the data patterns and/or formats stored in the credential pattern database 224A.

After a credential is found, the agent 222A is configured to transmit the data pattern associated with the credential to a credential analysis service 230A. The credential analysis service 230A is then configured to extract an identifier associated with the credential from the data pattern and identify a scope of permission, to which the identifier is granted. As illustrated in FIG. 2A, in some embodiments, the cloud service 210A has an administration module 216A configured to manage a user database 217A. The user database 217A stores a plurality of identifiers and their corresponding scope of permissions. A query API 218A is provided to allow the query of user information. In some embodiments, the credential analysis service 230A has first-party access to the administration module 216A or has been granted a scope of permission to access the administration module 216A. As such, the credential analysis service 230A can query the user database 217A via the query API to obtain the scope of permission associated with the identifier. The scope of permission is associated with a permission to access a cloud resource, which may or may not be the cloud resource 212A that is being scanned.

In some embodiments, in response to finding a cloud service password of a principal, the credential analysis service 230A is configured to identify a resource that the principal has access to or a project that the principal has access to. In some embodiments, in response to finding a Kubernetes kubeconfig file, the credential analysis service 230A is configured to identify a workload or a secret in a Kubernetes cluster. In some embodiments, in response to finding a cloud storage connection string, the credential analysis service 230A is configured to identify a container, a blob, or a bucket that a credential associated with the cloud storage connection string has access to. In some embodiments, in response to finding a container registry, the credential analysis service 230A is configured to identify a repository in the container registry and a scope of permission that a credential associated with the container registry has.

In response to identifying the cloud resource associated with the permission, the credential analysis service 230A can then identify an owner of the cloud resource. The owner may or may not be the user associated with the identifier contained in the found credential. In response to identifying the owner of the cloud resource, the credential analysis service 230A can then generate a security alert, notifying the owner of the cloud resource. For example, if the owner is associated with the cloud consumer computing system 220A, the credential analysis service 230A can send the security alert to the cloud consumer computing system 220A. Alternatively, or in addition, the credential analysis service 230A may also cause the agent 222A to delete the credential from the local storage 226A, modify or revoke the scope of permission associated with the credential, and/or reset a password associated with the credential. In some embodiments, which mitigating action is to be performed is based on an attribute or importance of the cloud resource and/or settings, which may be set by the owner of the credential, the owner of the cloud resource, the cloud service 210A, and/or the cloud service provider.

FIG. 2B illustrates another example process 200B of finding credentials from a cloud storage. As illustrated in FIG. 2B, a cloud service 210B is has a variety of resources, including a resource 212B. a cloud consumer computing system 220B is configured to access the cloud resource 212B over a network. At the same time, the cloud consumer computing system 220B also has a local storage 226B. In some cases, when a user of the cloud consumer computing system 220B accesses the cloud resource 212B, certain credentials associated with the cloud resource 212B may be stored locally in the local storage 226B. To mitigate the risk of exposure of the credential, an agent 222B is installed at the cloud consumer computing system 220B.

Unlike agent 222A shown in FIG. 2A (which is configured to extract data patterns associated with credentials), the agent 222B is configured to transmit at least a portion of data stored in the local storage 226B to a credential analysis service 230B, causing the credential analysis service 230B to store the portion of data in a second storage 234B (that is local to the credential analysis service 230B).

Also, unlike the credential analysis service 230A in FIG. 2A, the credential analysis service 230B is configured to access a credential pattern database 232B, and scan the portion of data received from the agent 222B based on the credential pattern database 232B to identify data patterns associated with credentials. After a data pattern associated with a credential is found, the credential analysis service 230B is then configured to extract an identifier associated with the credential and a scope of permission, to which the identifier is granted.

Similar to the cloud service 210A, the cloud service 210B may have an administration module 216B configured to manage a user database 217B and a query API 218B is provided to allow query of user information. The credential analysis service 230B can query the user database 217B via the query API to obtain the scope of permission associated with the identifier.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

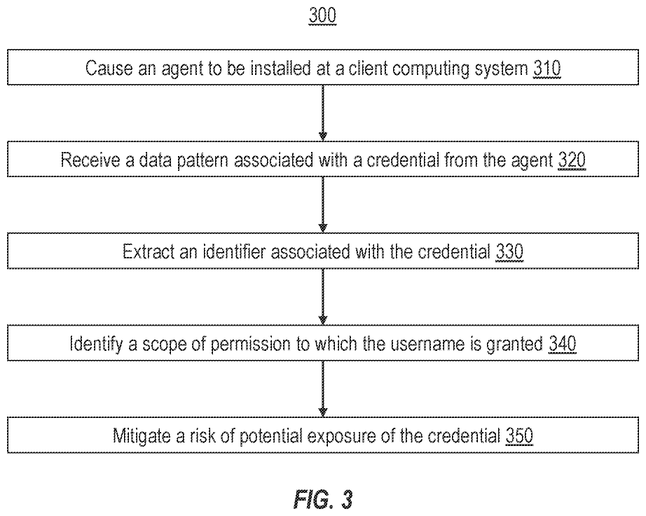

FIG. 3 illustrates a flowchart of an example method 300 for finding a credential from a local storage of a cloud consumer computing system. The cloud computing system is configured to access a cloud service. The method 300 includes causing an agent to be installed at the cloud consumer computing system (act 310). The agent is configured to scan at least a portion of storage of the cloud consumer computing system to find a data pattern associated with a credential.

In some embodiments, the data pattern is one of a plurality of predetermined data patterns. In some embodiments, the plurality of predetermined data patterns includes at least one of (1) a cloud service password of a principal, (2) a cloud service certificate of a principal, (3) a cloud service command-line interface (CLI) token, (4) a cloud service CLI credential, (5) a cloud application service publish setting file, (6) a Kubernetes kubeconfig file, (7) a cloud storage connection string, (8) a container registry credential, (9) a relational database service (RDS) secret, or (10) an OpenShift configuration file.

The method 300 further includes receiving the data pattern associated with the credential from the agent (act 320). Thereafter, an identifier associated with the credential is extracted (act 330), and a scope of permission that the identifier is granted is identified (act 340). The scope of permission is associated with a permission to access a cloud resource. In some embodiments, an owner associated with the cloud resource is also identified.

In some embodiments, in response to finding a cloud service password of a principal, the method 300 further includes identifying a resource that the principal has access to or a project that the principal has access to. In some embodiments, in response to finding a Kubernetes kubeconfig file, the method 300 further includes identifying a workload or a secret in a Kubernetes cluster. In some embodiments, in response to finding a cloud storage connection string, the method 300 further includes identifying a container, a blob, or a bucket that a credential associated with the cloud storage connection string has access to. In some embodiments, in response to finding a container registry, the method 300 further includes identifying a repository in the container registry and a scope of permission that a credential associated with the container registry has.

After the scope of permission is obtained, a risk of potential exposure of the credential is mitigated (act 350). Mitigating the risk of potential exposure of the credential includes (but is not limited to) at least one of (1) generating a security alert, notifying an owner of the cloud resource, (2) deleting the credential from the cloud storage, or (3) modifying or revoking the scope of permission associated with the credential. In some embodiments, which mitigating action is to be performed is based on an attribute or importance of the cloud resource associated with the credential, and/or based on a setting that may be set by the owner of the credential, the owner of the cloud resource, the cloud service, and/or the cloud service provider.

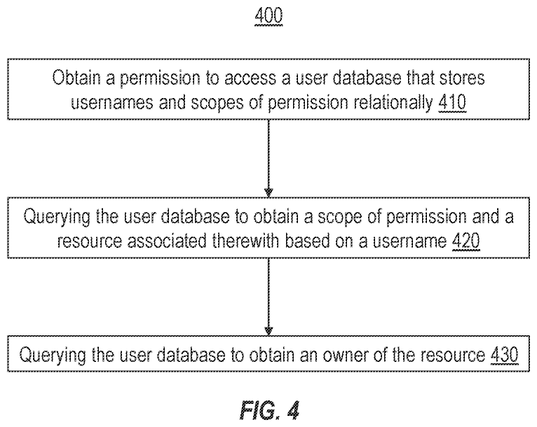

FIG. 4 illustrates a flowchart of an example method 400 for identifying a scope of permission to which an identifier is granted, which corresponds to act 340 of FIG. 3. The method 400 includes obtaining a permission to access a user database that stores identifiers and scope of permission relationally (act 410), and querying the user database to obtain a scope of permission and a resource associated therewith based on the identifier (act 420). The method 400 also includes querying the user database to obtain an owner of the cloud resource (act 430). Notably, the owner of the cloud resource may or may not correspond to the identifier associated with the found credential.

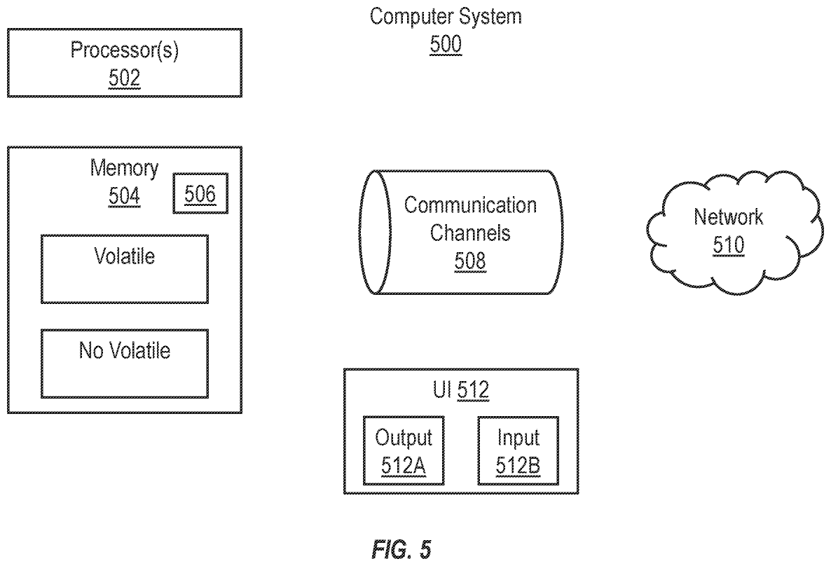

Finally, because the principles described herein may be performed in the context of a computing system (for example, each cloud service, cloud consumer computing system, or a credential analysis service includes one or more computing systems) some introductory discussion of a computing system will be described with respect to FIG. 5.

Computing systems are now increasingly taking a wide variety of forms. Computing systems may, for example, be hand-held devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 5, in its most basic configuration, a computing system 500 typically includes at least one hardware processing unit 502 and memory 504. The processing unit 502 may include a general-purpose processor and may also include a field-programmable gate array (FPGA), an application-specific integrated circuit (ASIC), or any other specialized circuit. The memory 504 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 500 also has thereon multiple structures often referred to as an “executable component”. For instance, memory 504 of the computing system 500 is illustrated as including executable component 506. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 504 of the computing system 500. Computing system 500 may also contain communication channels 508 that allow the computing system 500 to communicate with other computing systems over, for example, network 510.

While not all computing systems require a user interface, in some embodiments, the computing system 500 includes a user interface system 512 for use in interfacing with a user. The user interface system 512 may include output mechanisms 512A as well as input mechanisms 512B. The principles described herein are not limited to the precise output mechanisms 512A or input mechanisms 512B as such will depend on the nature of the device. However, output mechanisms 512A might include, for instance, speakers, displays, tactile output, holograms, and so forth. Examples of input mechanisms 512B might include, for instance, microphones, touchscreens, holograms, cameras, keyboards, mouse or other pointer input, sensors of any type, and so forth.

Embodiments described herein may comprise or utilize a special purpose or general-purpose computing system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hard-wired, wireless, or a combination of hard-wired or wireless) to a computing system, the computing system properly views the connection as a transmission medium. Transmissions media can include a network and/or data links that can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively or in addition, the computer-executable instructions may configure the computing system to perform a certain function or group of functions. The computer-executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing systems which may correspond to the computing system 500 previously described. The computing systems of the remaining figures include various components or functional blocks that may implement the various embodiments disclosed herein, as will be explained. The various components or functional blocks may be implemented on a local computing system or may be implemented on a distributed computing system that includes elements resident in the cloud or that implement aspect of cloud computing. The various components or functional blocks may be implemented as software, hardware, or a combination of software and hardware. The computing systems of the remaining figures may include more or less than the components illustrated in the figures, and some of the components may be combined as circumstances warrant. Although not necessarily illustrated, the various components of the computing systems may access and/or utilize a processor and memory, such as processing unit 502 and memory 504, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable hardware storage device having stored thereon computer-executable instructions that are structured such that, when the computer-executable instructions are executed by the one or more processors, the computing system is configured to:
cause an agent to be installed at a cloud consumer computing system, wherein the cloud consumer computing system is configured to access a cloud service, and the agent is configured to:
scan at least a portion of storage of the cloud consumer computing system for a data pattern associated with a credential; and
in response to finding the data pattern associated with the credential, send the data pattern to the computing system;
in response to receiving the data pattern associated with the credential from the agent,
extract an identifier associated with the credential based on the data pattern;
identify a scope of permission to which the identifier is granted, the scope of permission being associated with a permission to access a cloud resource; and
mitigate a risk of potential exposure of the credential, wherein mitigating the risk of potential exposure of the credential includes at least one of (1) generating a security alert, notifying an owner of the cloud resource, (2) causing the agent to delete the credential from the cloud consumer computing system, (3) modifying or revoking the scope of permission associated with the credential, or (4) resetting a password associated with the credential.

2. The computing system of claim 1, wherein the computing system is further configured to identify an owner of the cloud resource associated with the scope of permission.

3. The computing system of claim 1, wherein the cloud resource includes at least one of (1) a cloud storage, or (2) a cloud application.

4. The computing system of claim 1, wherein identifying the scope of permission comprises:
obtaining a permission to access a user database that stores identifiers and scopes of permission relationally;
querying the user database to obtain the scope of permission and the cloud resource associated therewith based on the identifier; and
querying the user database to obtain an owner of the cloud resource.

5. The computing system of claim 1, wherein the data pattern is one of a plurality of predetermined data patterns.

6. The computing system of claim 5, wherein the plurality of predetermined data patterns includes at least one of (1) a cloud service password of a principal, (2) a cloud service certificate of a principal, (3) a cloud service command line interface (CLI) token, (4) a cloud service CLI credential, (5) a cloud application service publish setting file, (6) a Kubernetes kubeconfig file, (7) a cloud storage connection string, (8) a container registry credential, (9) a relational database service (RDS) secret, or (10) an OpenShift configuration file.

7. The computing system of claim 6, wherein in response to finding a cloud service password of a principal, the computing system is configured to identify a resource that the principal has access to or a project that the principal has access to.

8. The computing system of claim 6, wherein in response to finding a Kubernetes kubeconfig file, the computing system is configured to identify a workload or a secret in a Kubernetes cluster.

9. The computing system of claim 6, wherein in response to finding a cloud storage connection string, the computing system is configured to identify a container, a blob, or a bucket that a credential associated with the cloud storage connection string has access to.

10. The computing system of claim 6, wherein in response to finding a container registry, the computing system is configured to identify a repository in the container registry and a scope of permission that a credential associated with the container registry has.

11. A method implemented at a computing system for finding credentials from a local storage of a cloud consumer computing system, the method comprises:
causing an agent to be installed at the cloud consumer computing system, wherein the cloud consumer computing system is configured to access a cloud service, and the agent is configured to:
scan at least a portion of storage of the cloud consumer computing system for a data pattern associated with a credential; and
in response to finding the data pattern associated with the credential, send the data pattern to the computing system;
in response to receiving the data pattern associated with the credential from the agent,
extracting an identifier associated with the credential based on the data pattern;
identifying a scope of permission to which the identifier is granted, the scope of permission being associated with a permission to access a cloud resource; and
mitigating a risk of potential exposure of the credential, wherein mitigating the risk of potential exposure of the credential includes at least one of (1) generating a security alert, notifying an owner of the cloud resource, (2) causing the agent to delete the credential from the cloud consumer computing system, (3) modifying or revoking the scope of permission associated with the credential, or (4) resetting a password associated with the credential.

12. The method of claim 11, wherein the method further comprises identifying an owner of the cloud resource associated with the scope of permission of the credential.

13. The method of claim 11, wherein the cloud resource includes at least one of (1) a cloud storage, or (2) a cloud application.

14. The method of claim 11, wherein identifying the scope of permission comprises:
obtaining permission to access a user database that stores identifiers and scopes of permission relationally;
querying the user database to obtain the scope of permission and the cloud resource associated therewith based on the identifier; and
querying the user database to obtain an owner of the cloud resource.

15. The method of claim 11, wherein the data pattern is one of a plurality of predetermined data patterns corresponding to a plurality of types of credentials.

16. The method of claim 15, wherein the plurality of predetermined data patterns includes at least one of (1) a cloud service password of a principal, (2) a cloud service certificate of a principal, (3) a cloud service command line interface (CLI) token, (4) a cloud service CLI credential, (5) a cloud application service publish setting file, (6) a Kubernetes kubeconfig file, (7) a cloud storage connection string, (8) a container registry credential, (9) a relational database service (RDS) secret, or (10) an OpenShift configuration file.

17. The method of claim 16, wherein the method further comprises in response to finding a cloud service password of a principal, identifying a resource that the principal has access to or a project that the principal has access to.

18. The method of claim 16, wherein the method further comprises in response to finding a Kubernetes kubeconfig file, identifying a workload or a secret in a Kubernetes cluster.

19. The method of claim 16, wherein the method further comprises in response to finding a cloud storage connection string, identifying a container, a blob, or a bucket that a credential associated with the cloud storage connection string has access to.

20. A computer program product comprising one or more hardware storage devices having stored thereon computer-executable instructions that are structured such that, when the computer-executable instructions are executed by one or more processors of a computing system, the computer-executable instructions configure the computing system to:
cause an agent to be installed at a cloud consumer computing system, wherein the cloud consumer computing system is configured to access a cloud service, and the agent is configured to:
scan at least a portion of storage of the cloud consumer computing system for a data pattern associated with a credential; and
in response to finding the data pattern associated with the credential, send the data pattern to the computing system;
in response to receiving the data pattern associated with the credential from the agent,
extract an identifier associated with the credential based on the data pattern;
identify a scope of permission to which the identifier is granted, the scope of permission being associated with a permission to access a cloud resource; and
mitigate a risk of potential exposure of the credential, wherein mitigating the risk of potential exposure of the credential includes at least one of (1) generating a security alert, notifying an owner of the cloud resource, (2) causing the agent to delete the credential from the cloud consumer computing system, (3) modifying or revoking the scope of permission associated with the credential, or (4) resetting a password associated with the credential.
